(19) United States
(12) Patent Application Publication
(10) Pub. No.: US 2025/0166533 A1
(43) Pub. Date: May 22, 2025

(54) Vehicle Identification Flag Device

(71) Applicant: Gail Ramsell, Central Islip, NY (US)

(72) Inventor: Gail Ramsell, Central Islip, NY (US)

(21) Appl. No.: 18/419,602

(22) Filed: Jan. 23, 2024

Related U.S. Application Data
(60) Provisional application No. 63/601,245, filed on Nov. 21, 2023.

(51) Int. Cl. G09F 17/00; B60Q 1/48

(52) U.S. Cl. CPC G09F 17/00; B60Q 1/482; G09F 2017/0075

(57) ABSTRACT

A vehicle location identification device comprising a telescopic handle with multiple extendable members and a flag member at the top is disclosed. The device includes an arcuate, flexible clip at the bottom for attachment to the vehicle. An illumination source near the handle's bottom end illuminates the flag for increased visibility. The clip has a vibration-resistant connection to the handle, designed for window mounting. In one embodiment, the device includes an anti-theft or motion sensor that triggers visual or audio alerts upon unauthorized movement. The flag also features a digital display for showing the vehicle's license plate number. The device extends above the roof of a vehicle and is designed to enhance the visibility, identification, and position of a vehicle in parking areas.

### CROSS-REFERENCE TO RELATED APPLICATION

The present application claims priority to, and the benefit of, U.S. Provisional Application No. 63/601,245, which was filed on Nov. 21, 2023, and is incorporated herein by reference in its entirety.

### FIELD OF THE INVENTION

The present invention generally relates to the field of vehicle-identifying devices. More specifically, the present invention relates to a novel flag device that functions as an identification marker for a vehicle. The device includes a telescopic handle to extend the flag and elevate same above the vehicle to allow users to easily identify the vehicle. The device utilizes an integrated LED light that illuminates the flag. The device is removably mounted on a door or a window of a vehicle and can be removed when not required. Accordingly, the present disclosure makes specific reference thereto. Nonetheless, it is to be appreciated that aspects of the present invention are also equally applicable to other like applications, devices, and methods of manufacture.

### BACKGROUND

By way of background, places such as malls, concert venues, sporting events, airports, and other large event locations often have large and complex parking areas. The parking areas can also be multi-level structures which adds to the complexity of the layout. Accordingly, individuals often have to park their vehicles in large, unfamiliar parking lots when visiting large venues such as malls, concerts, sporting events, and other events. The unfamiliar environment, coupled with the expansive size of the parking lots, increases the risk of individuals forgetting where they parked their car. This can lead to individuals walking around aimlessly, trying to spot their car among many others by identifying license plates or any other distinguishing features of their vehicle.

Walking aimlessly around a vast parking lot searching for a vehicle can be a frustrating and embarrassing experience for individuals. The feeling of being lost and unable to find a car can quickly escalate into anxiety and even fear, especially in crowded areas. While vehicle alarms can be helpful in locating a parked car, they can also attract unwanted attention, potentially bringing the car owner unwanted scrutiny. Additionally, retracing steps often proves ineffective due to the confusing layout of large parking lots. Parking attendants, while helpful in some situations, are not able to pinpoint the exact location of a parked car due to the number of vehicles under their supervision and the large area of parking.

With conventional methods, searching for a car in the parking areas can take valuable time away from enjoying the event or activity once attended. Also, the feeling of being lost and unable to find a car can lead to increased stress and anxiety, impacting the overall enjoyment of the outing. A frustrating parking experience can also leave a lasting negative impression of the venue or event. Many individuals, especially elderly individuals are not familiar with parking apps, and such apps are difficult to navigate and can also direct in the wrong direction because of the unavailability of a network. Individuals desire an efficient and discreet way to locate their parked vehicle without expending undue time and effort thereby creating a more positive and enjoyable experience.

Therefore, there exists a long-felt need in the art for a physical marker device for a vehicle for easily locating the vehicle in a parking area. Additionally, there is a long-felt need in the art for a device that can be removably attached to a vehicle when the vehicle is parked in an area. Moreover, there is a long-felt need in the art for a physical device that extends above a vehicle enabling a user to easily locate the vehicle. Further, there is a long-felt need in the art for a device that can be illuminated at night for enabling a vehicle owner to easily locate their vehicle. Furthermore, there is a long-felt need in the art for an innovative vehicle identification device that does not require any changes in the vehicle and is easy to use. Also, there is a long-felt need in the art for an innovative and user-friendly device that is in the form of a flag and can be attached to a vehicle to easily identify the vehicle's location from a long distance without requiring any additional assistance. Finally, there is a long-felt need in the art for a flag device that functions as an identification marker for a vehicle, thereby reducing time and effort in searching and locating the vehicle in a parking lot.

The subject matter disclosed and claimed herein, in one embodiment thereof, comprises a vehicle location identification flag device. The device is in the form of a flag and includes a telescopic handle that extends between a bottom end and a top end. The telescopic handle includes a plurality of telescopic members for extending the handle above the roof of the vehicle. A flag member is attached to the top end of the telescopic handle, the flag member includes an elongated staff and a flying or flag member, wherein the flying or flag member is adapted to be rolled or retracted around the staff when the device is not in use. A durable arcuate clip is integrated at the bottom end of the telescopic handle and the clip extends transversely from the handle. The clip is flexible while maintaining the arcuate shape thereof and is used for mounting the device on a window or a door (i.e., along an edge) of the vehicle. An illumination source is disposed on the telescopic handle near the bottom end and is capable of projecting light away and upwards from the handle to illuminate the flag member.

In this manner, the vehicle location identification flag device of the present invention accomplishes all of the foregoing objectives and provides users with a flag device that functions as an identification marker for a vehicle. The device is removably mounted on a vehicle using a clip or bracket, firmly securing the flag. The flag device extends above the vehicle for easy identification of the vehicle. The device eliminates the requirement of additional assistance, asking for directions, use of mobile phone applications, and reduces time and effort in searching a vehicle in a parking.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle location identification device. The device is in the form of a flag and further comprises a telescopic handle that extends between a bottom end and a top end. The telescopic handle includes a plurality of telescopic members for extending and retracting the handle. A flag member is attached to the top end of the telescopic handle, the flag member includes an elongated staff and a flying or flag member, wherein the flying or flag member is adapted to be rolled or retracted around the staff when the device is not in use. An arcuate clip or bracket is disposed at the bottom end of the telescopic handle and the clip or bracket extends transversely from the handle. The clip is flexible while maintaining the arcuate shape thereof and has a concave inner surface and a convex outer surface. An illumination source is disposed on the telescopic handle near the bottom end and is capable of projecting light away and upwards from the handle to illuminate the flag member.

In another aspect, a telescopic flag device for identifying the location of a vehicle in a parking area is disclosed. The flag device includes a cylindrical telescopic handle which includes a plurality of telescopic members for adjustable extension and retraction of the handle. A flag member is disposed at the top end of the handle and includes a fixed-length staff and a customizable flying or flag member. An arcuate, flexible bracket is integrated into the bottom end of the handle and is designed to securely attach the device to a vehicle edge or seam without disengaging. The bracket has a vibration-resistant connection with the handle to prevent detaching of the bracket from the handle. An LED is included for emitting light in single or multiple colors and a power source for providing power to the LED.

In yet another embodiment, a vehicle location identification device configured for mounting on a vehicle is disclosed. The device includes a telescopic handle extendable to a height such that a flag member attached to a top end of the handle remains vertically above a roof of the vehicle, enabling visibility and spotting of the flag device. An arcuate clip is disposed at a bottom end of the handle. It has a vibration-resistant connection with the handle, wherein the clip is adapted to be positioned on an outer surface of a window of the vehicle, with a free end of the clip positioned on an opposite side of the window, inside the vehicle. The clip is configured to be unbreakable and to retain the arcuate shape thereof, even when subjected to stresses such as closing of the window and door of the vehicle, or when the handle is pulled away from the vehicle in an installed position on the vehicle. When the device is installed on a vehicle, the clip abuts the interior surface of the vehicle, ensuring stability and visibility of the flag device well above the vehicle's roofline.

In yet another aspect of the present invention, a vehicle location identification flag device is disclosed. The device includes a telescopic handle, the handle is equipped with an anti-theft or motion sensor which is configured to generate an alert when the handle is moved while the device is installed on a vehicle. The alert can be a visual alert through a flashing LED and/or an audio alert via a speaker, activated upon detection of unauthorized movement of the handle. A flag is attached to the handle and features a digital display designed to display the license plate number of the vehicle on which the flag device is installed.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the vehicle location identification device of the present invention in accordance with the disclosed structure;

FIG. 2 illustrates a perspective view showing the vehicle location identification device of the present invention with folded flag in accordance with one embodiment of the present invention;

FIGS. 3A and 3B illustrate perspective views showing the vehicle location indicator device of the present invention installed on a vehicle in accordance with one embodiment of the present invention;

FIG. 4 illustrates a perspective view of another embodiment of the vehicle location indicator device of the present invention in accordance with the disclosed structure; and

FIG. 5 illustrates a flow chart depicting a process of using the vehicle location identification device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a physical marker device for a vehicle for easily locating the vehicle in a parking. Additionally, there is a long-felt need in the art for a device that can be removably attached to a vehicle when the vehicle is parked in an area. Moreover, there is a long-felt need in the art for a physical device that extends above a vehicle enabling a user to easily locate the vehicle. Further, there is a long-felt need in the art for a device that can be illuminated at night for enabling a vehicle owner to easily locate their vehicle. Furthermore, there is a long-felt need in the art for an innovative vehicle identification device that does not require any changes in the vehicle and is easy to use. Also, there is a long-felt need in the art for an innovative and user-friendly device that is in the form of a flag and can be attached to a vehicle to easily identify the vehicle's location from a long distance without requiring any additional assistance. Finally, there is a long-felt need in the art for a flag device that functions as an identification marker for a vehicle, thereby reducing time and effort in searching and locating the vehicle in a parking lot.

The present invention, in one exemplary embodiment, is a vehicle location identification device configured for mounting on a vehicle. The device is in the form of a flag and includes a telescopic handle extendable to a height such that a flag member attached to a top end of the handle remains vertically above a roof of the vehicle, enabling visibility of the flag device. An arcuate clip is disposed at a bottom end of the handle. It has a vibration-resistant connection with the handle, wherein the clip is adapted to be positioned on an outer surface of a window of the vehicle, with a free end of the clip positioned on an opposite side of the window, inside the vehicle. The clip is configured to be unbreakable and to retain the arcuate shape thereof, even when subjected to stresses such as closing of the window and door of the vehicle, or when the handle is pulled away from the vehicle in an installed position on the vehicle. When the device is installed on a vehicle, the clip abuts the interior surface of the vehicle.

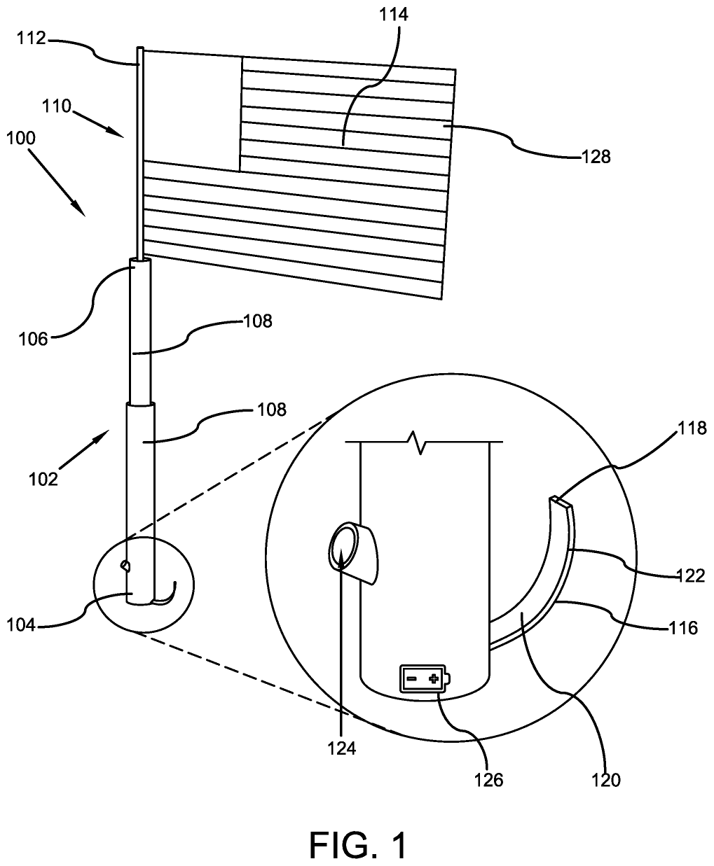

Referring initially to the drawings, FIG. 1 illustrates a perspective view of the vehicle location identification device of the present invention in accordance with the disclosed structure. The vehicle location identification device 100 of the present invention is designed as a marker or a location device to help users in identifying the location of their vehicle in an area such as in a parking lot. More specifically, the vehicle location identification device 100 is in the form of a telescopic flag and can be removably attached to a vehicle. The vehicle location indicator flag device 100 includes a telescopic handle or arm 102 extending between a bottom end 104 and a top end 106. The telescopic handle or arm 102 includes a plurality of telescopic members or sections 108 to extend (i.e., raise) and retract (i.e., lower) the flag device 100 to meet requirements of different users. The telescopic handle or arm 102 is preferably cylindrical but can be of any geometric shape.

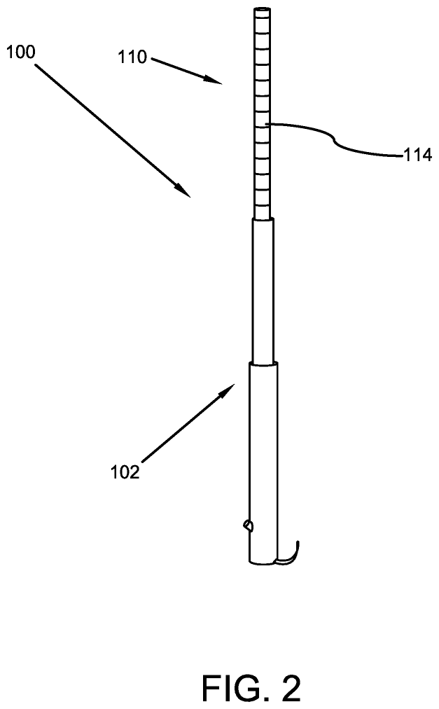

A flag terminal end 110 is attached to the top end 106 of the handle or arm 102 and the flag terminal end 110 includes an elongated staff 112 and a flying or flag member 114. The flying or flag member 114 can have any design and shape and is adapted to be rolled or retracted around the staff 112 as illustrated in FIG. 2. The staff 112 is preferably of a fixed length and is vertically extendable from the top end 106 of the handle or arm 102.

An arcuate clip or bracket 116 is disposed at the bottom end 104 of the handle or arm 102. The clip or bracket 116 extends transversely from the handle or arm 102, is flexible, and maintains the arcuate shape even when the handle or arm 102 and the free end 118 of the bracket 116 are pulled away from each other. Preferably, the clip or bracket 116 has a concave inner surface 120 and a convex outer surface 122. Further, the clip 116 has a vibration-resistant connection with the handle and does not disengage or detach from the handle or arm 102.

An illumination source 124 is disposed on the handle or arm 102 and preferably near the bottom end 104 of the handle or arm 102. The illumination source 124 can be low-power LED or any other similar light source. The illumination source 124 is disposed to project light away and upwards from the handle or arm 102 illuminating the flag device 100 during lowlight hours. The illumination source 124 can be solar powered or alternatively can be powered using a power source 126 disposed in the handle or arm 102. The power source 126 can be any conventional batteries which can be replaced and/or recharged by accessing through the bottom end 104 of the handle or arm 102. The illumination source 124 can be of a single color or can illuminate in multiple colors. In some embodiments, the LED 124 having a sensor for automatically activating the LED 124 when low light is sensed by the LED 124.

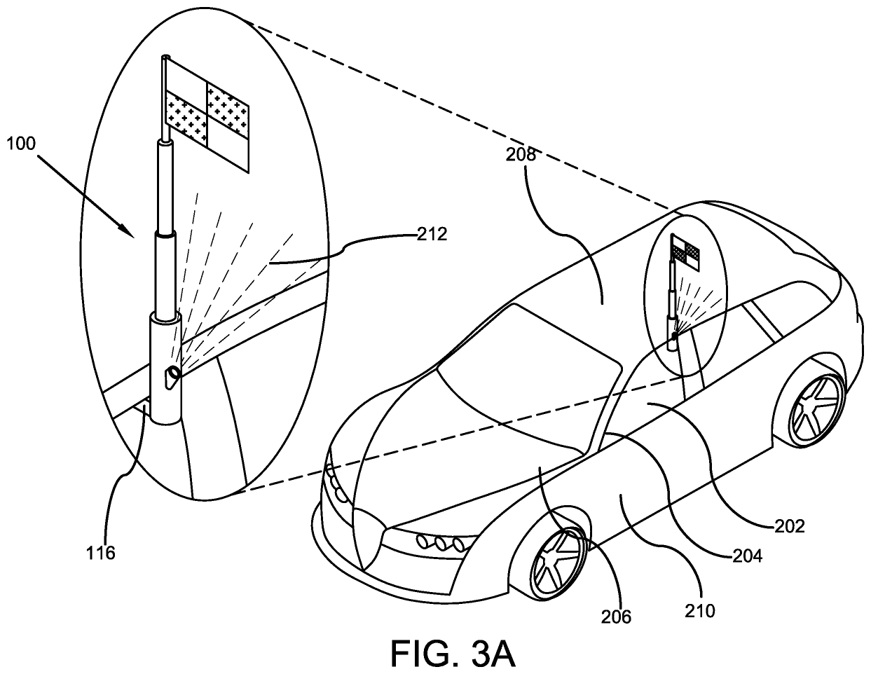

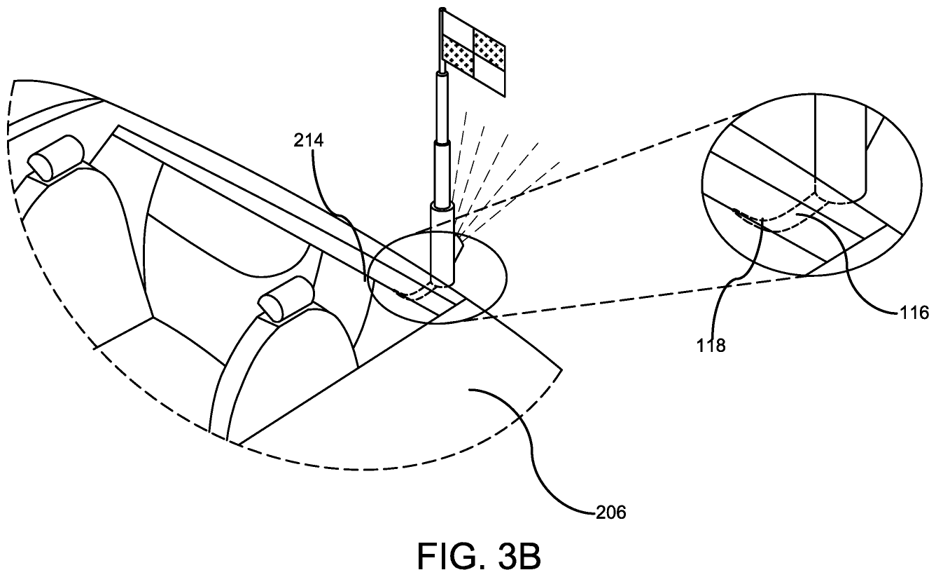

The flag device 100 is made of a weatherproof and lightweight material such as plastic, metal, alloy, or any other similar material. Further, the flag device 100 is removably attached to a vehicle as illustrated in FIG. 3 for enabling the vehicle owner to easily identify the vehicle's location in a parking area. The flag device 100 can come in different styles and colors to customize the look and ensure that the vehicle is easily found.

FIG. 2 illustrates a perspective view showing the vehicle location identification device of the present invention with folded flag in accordance with one embodiment of the present invention. The flag terminal end 110 is rotatable 360 degrees with a user manually turning the staff 112 to rotate the flag terminal end 110. The flying or flag member 114 can be rolled or retracted around the staff 112 to easily store the flag device 100 in a vehicle. In some embodiments, the fly end 128 may include an adhesive to secure the flying or flag member 114 in the rolled state. In some embodiments, the vehicle location indicator device 100 can include a motor (not shown) to turn the flag terminal end 110, thereby eliminating manual operation of turning the staff 112.

FIGS. 3A and 3B illustrate perspective views showing the vehicle location indicator device of the present invention installed on a vehicle in accordance with one embodiment of the present invention. As illustrated in FIG. 3A, the flag device 100 is positioned on the outer surface 202 of a window 204 of the vehicle 206 such that the free end 118 of the arcuate clip 116 is positioned on opposite side/inside of the window 204. The handle or arm 102 is extended to a height such that the flag terminal end 110 remains vertically above the roof 208 of the vehicle 206 for enabling users to easily see the flag device 100. The vibration-resistant connection of the clip 116 and the handle or arm 102 enables the handle or arm 102 to remain erect when the door 210 of the vehicle 206 is closed.

The illumination source 124 is strategically positioned such that the illumination 212 thereof is projected away from vehicle 206 and upwards to make the flag device 100 visible even in low light. It will be apparent to a person skilled in the art that the clip 116 is designed not to break when the window 204 and the door 210 are closed and also when the handle or arm 102 is pulled away from the vehicle 206 during installed position.

As illustrated in FIG. 3B, the position of the clip 116 inside the vehicle 206 is shown when the flag device 100 is installed on the vehicle 206. The clip 116 being in arcuate or C-shape is positioned inside the vehicle 206 and the free end 118 abuts the interior surface 214 of the vehicle 206. The clip 116 is unbreakable and retains the shape thereof even after being used in the installed position for days.

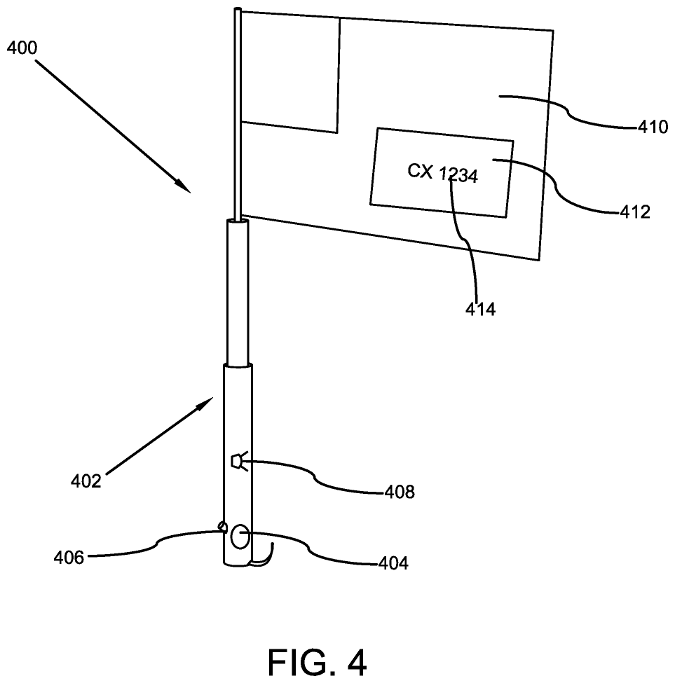

FIG. 4 illustrates a perspective view of another embodiment of the vehicle location indicator device of the present invention in accordance with the disclosed structure. In the present embodiment, the handle 402 of the flag device 400 includes an anti-theft or motion sensor 404 for generating an alert when the handle 402 is pulled or pushed while the flag device 400 is installed on a vehicle. The alert can be a visual alert in which the LED 406 flashes or can also be in the form of an audio alert from the speaker 408.

The flying or flag member 410 may include a digital display 412 for displaying text such as license plate number 414 of the vehicle on which the flag device 400 is installed. This is helpful in cases where multiple vehicles have the same design of the flag device 400.

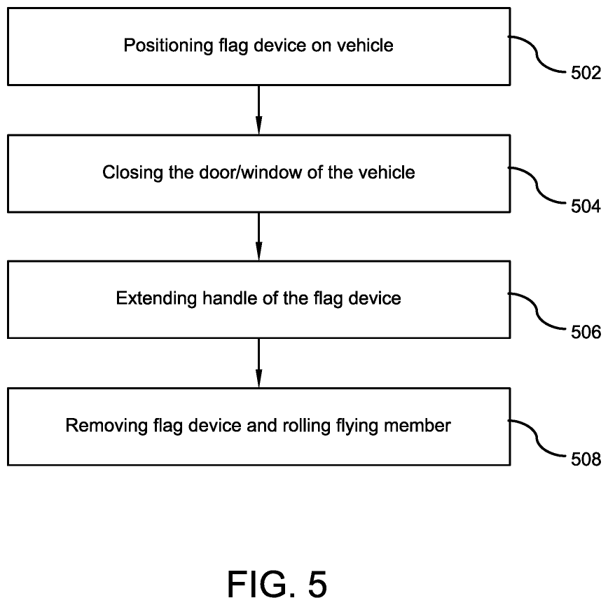

FIG. 5 illustrates a flow chart depicting a process of using the vehicle location identification device of the present invention in accordance with the disclosed structure. Initially, the flag device is positioned outside a door/window of a vehicle such that the clip 116 extends on the opposite side of the door/window and inside the vehicle (Step 502). Then, the door/window is closed such that the handle of the flag device 100 is supported by the vehicle (Step 504). Thereafter, the handle is extended to a desired height with the flag member positioned above the roof of the vehicle (Step 506). Finally, when the device is not required, the flag device is removed/uninstalled and the flying or flag member is rolled for easy storage (Step 508).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle location identification device”, “flag device”, “vehicle location indicator flag device”, and “vehicle location indicator flag device” are interchangeable and refer to the vehicle location indicator flag device 100, 400 of the present invention.

Notwithstanding the foregoing, the vehicle location indicator flag device 100, 400 of the present invention can be of any suitable size and configuration as is known in the art without affecting the overall concept of the invention, provided that it accomplishes the above-stated objectives. One of ordinary skill in the art will appreciate that the vehicle location indicator flag device 100, 400 as shown in the FIGS. is for illustrative purposes only, and that many other sizes and shapes of the vehicle location indicator flag device 100, 400 are well within the scope of the present disclosure. Although the dimensions of the vehicle location indicator flag device 100, 400 are important design parameters for user convenience, the vehicle location indicator flag device 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle location identification device comprising:
a telescopic arm having a top end and a bottom end;
an elongated staff;
a flag member;
a flexible arcuate clip; and
an illuminator;
wherein said flexible arcuate clip proximal to said bottom end for securing in a seam of a vehicle;
wherein said flexible arcuate clip extending transversely from said telescopic arm;
wherein said telescopic arm having a plurality of telescopic sections for selectively raising and lowering said flag member; and
further wherein said flag member having a selectable position from a retracted position to an extended position relative to said elongated staff for identifying a location of a vehicle when said flag member is in the extended position.

2. The vehicle location identification device of claim 1, wherein said elongated staff extendable from said top end of said telescopic arm.

3. The vehicle location identification device of claim 2, wherein said flexible arcuate clip having a concave inner surface.

4. The vehicle location identification device of claim 3, wherein said illuminator proximal to said bottom end of said telescopic arm for selectively illuminating said flag member.

5. The vehicle location identification device of claim 4, wherein said illuminator having a solar panel for powering said illuminator.

6. The vehicle location identification device of claim 4, wherein said illuminator having a battery for powering said illuminator.

7. The vehicle location identification device of claim 6, wherein said seam is between a passenger door window and a vehicle body panel.

8. A vehicle location identification device comprising:
a telescopic arm having a top end and a bottom end;
an elongated staff;
a flag member;
a flexible arcuate clip; and
an illuminator;
wherein said flexible arcuate clip proximal to said bottom end for selectively securing in a seam of a vehicle;
wherein said flexible arcuate clip extending transversely from said telescopic arm;
wherein said telescopic arm having a plurality of telescopic sections for selectively raising and lowering said flag member;
wherein said flag member having a selectable position from a retracted position to an extended position relative to said elongated staff for identifying a location of a vehicle when said flag member is in the extended position;
wherein said illuminator proximal to said bottom end of said telescopic arm for selectively illuminating said flag member; and
further wherein said seam is between a passenger door window and a vehicle body panel.

9. The vehicle location identification device of claim 8, wherein said elongated staff extendable from said top end of said telescopic arm.

10. The vehicle location identification device of claim 9, wherein said flexible arcuate clip having a concave inner surface.

11. The vehicle location identification device of claim 10, wherein said illuminator having a solar panel for powering said illuminator.

12. The vehicle location identification device of claim 10, wherein said illuminator having a battery for powering said illuminator.

13. A vehicle location identification device comprising:
a telescopic arm having a top end and a bottom end;
an elongated staff;
a flag member;
a flexible arcuate clip;
an illuminator; and
a first sensor;
wherein said flexible arcuate clip proximal to said bottom end for selectively securing in a seam of a vehicle;
wherein said flexible arcuate clip extending transversely from said telescopic arm;
wherein said telescopic arm having a plurality of telescopic sections for selectively raising and lowering said flag member;
wherein said flag member having a selectable position from a retracted position to an extended position relative to said elongated staff for identifying a location of a vehicle when said flag member is in the extended position;
wherein said first sensor automatically actuates said illuminator when low light is sensed; and
further wherein said seam is between a passenger door and a vehicle body panel.

14. The vehicle location identification device of claim 13, wherein said elongated staff extendable from said top end of said telescopic arm.

15. The vehicle location identification device of claim 13, wherein said flexible arcuate clip having a concave inner surface.

16. The vehicle location identification device of claim 13, wherein said illuminator having a solar panel for powering said illuminator.

17. The vehicle location identification device of claim 13, wherein said illuminator having a battery for powering said illuminator.

18. The vehicle location identification device of claim 13, wherein said illuminator proximal to said bottom end of said telescopic arm for selectively illuminating said flag member.

19. The vehicle location identification device of claim 13, wherein said telescopic arm having a second sensor, and further wherein said second sensor for detecting motion of said telescopic arm and generating an alert in response to said detecting motion.

20. The vehicle location identification device of claim 19, wherein said alert is selected from the group consisting of an audible alert and a visual alert.
